(19) United States
(12) Patent Application Publication
(10) Pub. No.: US 2022/0339956 A1
(43) Pub. Date: Oct. 27, 2022

(54) SMART BANKNOTES

(71) Applicant: Leandro Antônio Gonçalves GIORDANO, Brasília (BR)

(72) Inventor: Leandro Antônio Gonçalves GIORDANO, Brasília (BR)

(21) Appl. No.: 17/766,002

(22) PCT Filed: Oct. 1, 2020
(86) PCT No.: PCT/BR2020/050395

§ 371 Date: Apr. 1, 2022

(30) Foreign Application Priority Data
Oct. 4, 2019 (BR) BR10 2019020997 6

(51) Int. Cl. B42D 25/29; G06K 19/077

(52) U.S. Cl. CPC B42D 25/29; G06K 19/077

(57) ABSTRACT

Smart banknotes incorporating permanent data transmission and reception elements to enable the storage of encrypted and unencrypted data that can be accessed at medium distances using electronic equipment, thereby enabling the definition/description of the banknote, the registration thereof, the central bank serial number and history, and other security data of interest, enabling security and control plans. The banknotes help people with visual impairments to identify banknotes and the value thereof, fostering greater social inclusion and independence when handling cash, and will be very useful for recognizing different types of banknotes, including in all countries that adopt the system. The banknotes may be used with everyday equipment on the market such as gadgets, and also drawers, counters, ATMs, and the like. Since they can provide audio and/or visual information, it is of greater use and efficiency in comparison to any existing product, and therefore has broad market applicability and social utility.

### FIELD

The invention refers to an intelligent monetary transactions product (banknotes) of self-identification by visual, audible and electronic means in a passive way, with data transmission and reception element, (transponders) in its composition being an indissoluble part of it.

### BACKGROUND

Produced as cash, it was developed with the addition of a data transmission and reception element (transponder), a resistant and first-rate high-level electronic data device and, considering that monetary systems leave much to be desired in terms of security, with regard to counterfeiting and tracking and that such current factors of secure and traceable banknotes are still ineffective and incipient in absolute terms, so much so that they represent a small percentage of attempts at global success in terms of cash, this is a new product, a new material that will supply all these issues in addition to many others, such as the lack of banknotes that meet the needs of blind and visually impaired people and that meet the Brazilian and international laws and requirements of accessibility, rights of people with disabilities and also technological development to meet the technological intelligence that has been produced worldwide with the implementation of the ioT, Al and smart cities and humanitarian programs, not having been explored in the sense of data transmitter, which makes the monetary banknotes with data transmission and reception element (transponder), become revolutionary in the safe cash market and also in the technological segment internet of things (ioT). This makes the invention not only a monetary banknote, but a high-tech computerization product that can become part of an IT (Information Technology) system and even more complex systems such as Intelligence and Security.

### SUMMARY

In this way, it allows the storage of encrypted and unencrypted data that can be accessed at medium distances (approximately up to 10 meters) through electronic equipment, thus allowing the definition, description of the banknote, its registration, series in the Central Bank and its history, in addition to other safety data that there is interest in having access according to each Country, which can always be changed or added with new data.

### DETAILED DESCRIPTION

This invention allows users who are blind or not, to know the descriptions of this cash. It allows security and control plans. The invention was developed to supply the visual deficiencies in the identification of cash banknotes, thus allowing the identification of their value by the visually impaired and even knowing if it is not a forgery, thus enabling a greater inclusion of them in society and creating independence of the blind regarding the handling of cash. In the case of blind people, it is of great value to recognize various types of banknotes, including all countries that adopt the system. It can be used through common market equipment, such as Gadgets: cell phones, Smartphone, tablets, watches, bracelets, lanyards, etc., as well as counters, ATMs, drawers, safes, furniture, and the like. Depending on the type of application, it is possible to have information in audio and/or visual media. This will entail a lot of improvement in its use and efficiency in comparison to any existing product, resulting in a wide market, safety and beyond a social utility.

This invention is an intelligent monetary banknote of paper, plastic, fabric or any synthetic composite material, with data transmission and reception element (transponder), a product of exceptional physical and mechanical characteristics. It consists of banknotes with physical characteristics and design of each country variable in weight and dimensions, where the data transmission and reception elements, transponders, arranged in a very compact, extremely thin and flexible high technology result, will be added, resulting in a composite element, consisting of materials pertinent to the banknotes used in each country that involved each of the particles of the data transmission and reception elements (transponders). An adhesion promoter fosters an indissoluble bond between the banknote molecules, the polymer chains, and the transmission elements.

It is the current reality and the purpose of enabling a favorable modification to quality, technology and aesthetics itself with regard to meeting the needs of a market, a social situation of integration, development of technology and communication, inclusion and Brazilian and international accessibility legislation. As for the accessibility and the right of disabled people, they will also attend, without the use of “cats and dogs”, because the solution so far found is the dimension of the notes and minimum reliefs that are lost with the use of the banknotes. Therefore, to meet a wider range of requests for the use of an accessible banknote, its proposal was developed with data transmission and reception elements (transponder), intelligent banknote, with a new configuration of compounds, being important the great possibility of variables of interaction between user and object.

The object of this patent consists of the use of banknotes composed of data transmission and reception elements (transponder), characterizing an intelligent system, with standards for the perception and guidance of visually impaired people and their own monetary security systems.

These intelligent systems meet the needs of accessibility making the set accessible without depreciating its security but increasing it, with regard to quality, durability, resistance, information and tracking. And it enables high performance security and technological investigative solutions, where you can combine the data transmission and reception elements (transponder), with other security and traceability systems necessary for each specific case.

Another great use of these banknotes is the automation of ordinary services but of great work, fragility and loss of time, which is the counting of these cash in situations ranging from the simple drawers of boxes of trades, banks to the coffers of the Banks, while at the same time counting the identification of each banknote, therefore meeting the legal requirements and the needs of each segment that makes use of the paper currency in its activities, thus uniting functionality, technology and accessibility.

Developed to be applied integrated in any type of system of execution of existing banknotes, where it is necessary to exchange information between the being and the object, intended for sensory perception, circulation, identification and tracking of cash and service to people with visual impairment or not, aiming at the integration and description of the object, equipment, elements etc. for various purposes, such as alert to values and situations of fraud or deception, in any internal and external environments, being the same developed in different shapes and dimensions, as already practiced in each country. Therefore, not adding greater expenses with regard to standardization of dimensions that had already been applied in any system, makes the place of its use interactive with the user and with other elements of artificial intelligence thus composing a system of the Internet of Thinks (IoT), and as it is fully integrated and programmable, it can be used in various ways in accessibility, security and accounting etc.

The possibility of connecting to the internet enables access remotely as service providers, this ability generates a large number of opportunities in the technological, industrial and social sphere.

From then on, the banknotes will not only have ears, but they also spoke and will be able to interact with whoever is in the created environment. In this way, the conventional banknote cash system is transformed into a smart banknote cash system. And the smart banknote set will have the smart teller system, the smart money security system and so on. An interactive financial world, safe and accessible to all even for those who are blind who will interact with the world through hearing as well as the deaf will interact through sight and there will be a possible solution for each sensory deficiency.

As a smart currency, in addition to composing the financial environment in a rational way, this environment will become fully interactive with both users and equipment that will be able to interact with the banknotes and thus complement a sequence of IoT, Internet of Things. A real high-performance and futuristic element.

Further embodiments describe intelligent banknotes as a product of intelligent monetary transactions (banknotes) of self-identification by visual, audible and electronic means in a passive way, wherein the data transmission and reception elements (transponders) in composition of the intelligent banknotes allow the storage of encrypted and unencrypted data that can be accessed at medium distances of approximately up to 10 meters, through electronic equipment, allowing the definition, description of the banknote, its registration, series in the Central Bank and its history, in addition to other security data according to each country; they further allow blind users or not to know the descriptions of this cash, developed to meet the visual deficiencies in the identification of cash notes, allowing the identification of the value of the same by the visually impaired, enabling a greater inclusion of them in society and creating independence of these regarding the handling of cash that will be of great value for recognition of various types of banknotes, including all countries that adopt the system, which can be used through common market equipment, such as Gadgets, Smartphones, tablets, watches, bracelets, cords, etc., as well as counters, ATM, drawers, furniture, safes, and the like; according to the type of application may have information in audio and/or visual causing a lot of improvement in its use and efficiency, a market breadth beyond a social nobility, meaning inclusion, security, an intelligent monetary note of paper, plastic, fabric or any synthetic material composed with transponder; a product of exceptional physical and mechanical characteristics consisting of banknotes with physical characteristics and design of each country variable in weight and dimensions, where will be added the transponders arranged in a very compact, extremely thin and flexible result of high technology, resulting in a composite element, consisting of materials pertinent to the banknotes of each country that involve each of the particles of the transponders; an adhesion promoter promotes an indissoluble link between the molecules of the banknotes, the polymer chains and the transmitter elements, resistant and first-rate of high level this new product, new material, and still not having banknotes that meet the needs of blind and visually impaired and that meets the laws and requirements of Brazilian and international accessibility, rights of people with disabilities and also technological development to meet the technological intelligence that has been produced worldwide. makes the monetary banknotes with data transmission and reception element (transponder), become revolutionary in the safe cash market and also on the internet of things IoT technological segment, making this invention in question not only a monetary banknote, but a high-tech computerization product that can become part of an IT (Information Technology) system and even more complex systems such as Intelligence and Security of a country.

1. (canceled)

2. Intelligent banknotes, comprising: a product of intelligent monetary transactions (banknotes) of self-identification by visual, audible and electronic means in a passive way, wherein the data transmission and reception elements (transponders) in composition of the intelligent banknotes allow the storage of encrypted and unencrypted data that can be accessed at medium distances of approximately up to 10 meters, through electronic equipment, allowing the definition, description of the banknote, its registration, series in a central bank and its history, in addition to other security data according to each country; they further allow blind users or not to know the descriptions of this cash, developed to meet the visual deficiencies in the identification of cash notes, allowing the identification of the value of the same by the visually impaired, enabling a greater inclusion of them in society and creating independence of these regarding the handling of cash that will be of great value for recognition of various types of banknotes, including all countries that adopt the system, which can be used through common market equipment, including gadgets, smartphones, tablets, watches, bracelets, cords, counters, ATM, drawers, furniture, and safes; according to the type of application may have information in audio and/or visual causing a lot of improvement in its use and efficiency, a market breadth beyond a social nobility, meaning inclusion, security, an intelligent monetary note of paper, plastic, fabric or any synthetic material composed with transponder; a product of exceptional physical and mechanical characteristics consisting of banknotes with physical characteristics and design of each country variable in weight and dimensions, where will be added the transponders arranged in a very compact, extremely thin and flexible result of high technology, resulting in a composite element, consisting of materials pertinent to the banknotes of each country that involve each of the particles of the transponders; an adhesion promoter promotes an indissoluble link between the molecules of the banknotes, the polymer chains and the transmitter elements, resistant and first-rate of high level this new product, new material, and still not having banknotes that meet the needs of blind and visually impaired and that meets the laws and requirements of Brazilian and international accessibility, rights of people with disabilities and also technological development to meet the technological intelligence that has been produced worldwide. makes the monetary banknotes with data transmission and reception element (transponder), become revolutionary in the safe cash market and also on the internet of things IoT technological segment, making this invention in question not only a monetary banknote, but a high-tech computerization product that can become part of an IT (Information Technology) system and even more complex systems such as Intelligence and Security of a country.
